(19) United States
(12) Patent Application Publication
(10) Pub. No.: US 2003/0054806 A1
(43) Pub. Date: Mar. 20, 2003

(54) System and method for defining, creating and deploying wireless applications

(76) Inventors: Raymond Ho, North York (CA); Edward Fung, North York (CA)

Correspondence Address: Patricia Smink Rogowski, Connolly Bove Lodge & Hutz LLP, P.O. Box 2207, Wilmington, DE, 19899, US

(21) Appl. No.: 10/219,952

(22) Filed: Aug. 15, 2002

Related U.S. Application Data
(60) Provisional application No. 60/312,071, filed on Aug. 15, 2001.

(51) Int. Cl. H04M 3/42

(52) U.S. Cl. 455/414; 455/412

(57) ABSTRACT

A system and method for conveying a WAP application to a WAP compliant wireless device comprises a WAP compliant wireless device generating a WAP request. A WAP gateway generates a web request in response to the WAP request and conveys the web request to a web server over the Internet. A WAP server reads application definitions from a database that are appropriate for generating a WAP response in response to the WAP request and dynamically generates WML code forming the WAP response using the application definitions read from the database. The WAP server transmits the WAP response to the WAP compliant wireless device via the web server, Internet and WAP gateway. A WAP application builder and method are also provided.

### CROSS-RELATED APPLICATIONS

The present application claims the benefit of U.S. Provisional Application Serial No. 60/312,071 filed on Aug. 15, 2001 for an invention entitled “System and Method for Defining, Creating and Deploying WAP Applications”.

### FIELD OF THE INVENTION

The present invention relates generally to wireless devices and in particular to a system and method for defining, creating and deploying applications for wireless devices.

### BACKGROUND OF THE INVENTION

Wireless devices such as mobile or cellular telephones, pagers and Personal Digital Assistants (PDAs) have gained wide acceptance in today's society. Over the past years wireless devices of this nature have provided users with increased features including Internet access. Unfortunately, these wireless devices suffer limitations that inhibit the wireless devices from taking full advantage of Internet services. These limitations include low bandwidth, high latency, and connection availability of wireless networks as well as limited memory, execution speed, small display screens and small keypads.

To standardize competing protocols, extend Internet services to wireless devices, and deal with some of the above-mentioned limitations, the Wireless Application Protocol (WAP) was established by the WAP Forum consortium. WAP compliant wireless devices typically execute WAP applications written in Wireless Markup Language (WML). WML is similar to Hyper Text Markup Language (HTML), the language used to write most Internet applications executed by Internet browsers. Similar to HTML, WML has the advantage of being platform independent, provided the WAP compliant wireless device runs a browser program that can interpret the language properly.

When a WAP compliant wireless device initiates an Internet session and generates web requests, WAP applications are delivered to the WAP compliant wireless device in the form of decks of WML “cards”. Each WML card is the functional equivalent of a web page. When a deck of WML cards is received by the WAP compliant wireless device, the WML cards are executed by the browser running on the WAP compliant wireless device and displayed on its screen. Using the browser, a user is able to page through the deck of WML cards and generate additional web requests.

A number of different WAP applications have been developed since the inception of the WAP specifications, but unfortunately most WAP applications are still developed in a specific and ad-hoc manner. As a result, WAP application developers still encounter a number of unresolved issues.

As mentioned previously, WAP compliant wireless devices suffer from a number of limitations. In addition, there are substantial differences in the limitations of various WAP compliant wireless devices. As a result WAP application developers must keep these limitations in mind when developing WAP applications to be deployed across a variety of WAP compliant wireless devices. Inevitably, WAP application developers take the lowest common denominator approach and write WAP applications for WAP compliant wireless devices that suffer the most severe limitations, knowing that if this is done, the WAP applications will be able to run on virtually all WAP compliant wireless devices. The end result is that most, if not all WAP applications, fail to take advantage the available resources of many WAP compliant wireless devices.

Although the adoption of WAP standards was intended to make WAP applications platform independent, it has been found that many WAP applications behave differently when executed by browsers running on different types of WAP compliant wireless devices. Unfortunately, WAP applications provide little, if any facility to change the WML code on-the-fly to handle particularities of various WAP compliant wireless devices.

During WAP application development, most WAP application developers use some form of editor to write the WML code. As a result, WAP application developers must learn and understand the syntax and semantic of WML before they are able to effectively develop WAP applications. In addition, since WAP supports multilingual user interfaces using Unicode (an encoding standard for International languages), WAP application developers sometimes are required to deal with the issues relating to the interchange of Unicode with other encoding formats that exist in current systems. Furthermore WML does not support database access. It is up to WAP application developers to use the necessary protocols to permit WAP applications to access database systems. The handling of database transactions and error conditions therefore has to be dealt with each and every time a new WAP application is developed.

Unfortunately, to-date editors used to write WML code provide no means to expedite or facilitate WAP application development. Also, these editors provide little, if any ability to interchange Unicode with other encoding formats. Furthermore, these editors provide little, if any means to shield WAP application developers from technical protocol details when developing WAP applications that require database access. As will be appreciated, a need exists to assist WAP application developers.

It is therefore an object of the present invention to provide a novel system and method for defining, creating and deploying applications for wireless devices.

### SUMMARY OF THE INVENTION

According to one aspect of the present invention there is provided a method of conveying a WAP application to a WAP compliant wireless device comprising the steps of:

in response to a WAP request generated by the WAP compliant wireless device, reading application definitions from a database that are appropriate for generating a WAP response to said WAP request;

generating WML code forming said WAP response using the application definitions read from said database; and

transmitting said WAP response to said WAP compliant wireless device.

According to another aspect of the present invention there is provided a method of conveying a WAP application to a WAP compliant wireless device comprising the steps of:

generating a WAP request using a WAP compliant wireless device;

conveying the WAP request to a WAP gateway;

at the WAP gateway generating a web request in response to the WAP request and conveying the web request to a web server over the Internet;

at the web server generating a WAP request in response to the web request and conveying the WAP request to a WAP server;

at said WAP server reading application definitions from a database that are appropriate for generating a WAP response in response to said WAP request and dynamically generating WML code forming said WAP response using the application definitions read from said database; and

transmitting said WAP response to said WAP compliant wireless device via said web server, Internet and WAP gateway.

According to another aspect of the present invention there is provided a system for conveying a WAP application to a WAP compliant wireless device comprising:

a WAP compliant wireless device generating a WAP request;

a WAP gateway generating a web request in response to the WAP request and conveying the web request to a web server over the Internet; and

a WAP server reading application definitions from a database that are appropriate for generating a WAP response in response to said WAP request and dynamically generating WML code forming said WAP response using the application definitions read from said database, said WAP server transmitting said WAP response to said WAP compliant wireless device via said web server, Internet and WAP gateway.

According to yet another aspect of the present invention there is provided a WAP application builder comprising:

a graphical user interface defining WAP application definitions in response to user input; and

a WAP generator creating application definition data in response to defined application definitions.

According to still yet another aspect of the present invention there is provided a method for building a WAP application comprising the steps of:

defining WAP application definitions in response to user input through a graphical user interface; and

creating application definition data in response to defined application definitions.

The present invention provides advantages in that WAP applications can be developed quickly, easily and cost-effectively. This is achieved by providing a graphical user interface that allows WAP application developers to define WAP applications easily using intuitive definitions thereby shielding WAP application developers from the technical complexities of WAP protocols and standards. In this manner, WAP application developers are able to focus on the development of WAP applications.

### BRIEF DESCRIPTION OF THE DRAWINGS

An embodiment of the present invention will now be described more fully with reference to the accompanying drawings in which:

FIG. 1 is a diagrammatic overview of the conventional manner by which a WAP compliant wireless device accesses a WAP application over the Internet;

FIG. 2 is a diagrammatic overview of the manner by which a WAP compliant wireless device accesses a WAP application over the Internet in accordance with the present invention;

FIG. 3 is a flow diagram showing an exemplary WAP application including a plurality of application definintions;

FIG. 4 is a schematic block diagram of a WAP builder used to construct application definitions for WAP applications in accordance with the present invention; and

FIGS. 5a to 5ooo are screen shots showing the steps performed during creation of application definitions for a stock quote WAP application.

### DETAILED DESCRIPTION OF THE PREFERRED EMBODIMENT

The present invention relates generally to a system and method for generating and deploying WAP applications specified by user intuitive application definitions through a graphical user interface. The system includes two primary components, namely a WAP application builder and a WAP server. The WAP application builder allows a user to define application definitions for a WAP application and to view the WAP application flow in graphical form. The application definitions, which define action steps in the WAP application, are stored in a database. When the database of application definitions is deployed, the WAP server uses the application definitions to create WML code necessary to generate WAP responses in response to WAP requests received from a WAP compliant wireless device. The WML code is generated dynamically and is delivered to the WAP compliant wireless device over the Internet via conventional web servers. Specifics of the present invention will now be described with reference to the Figures.

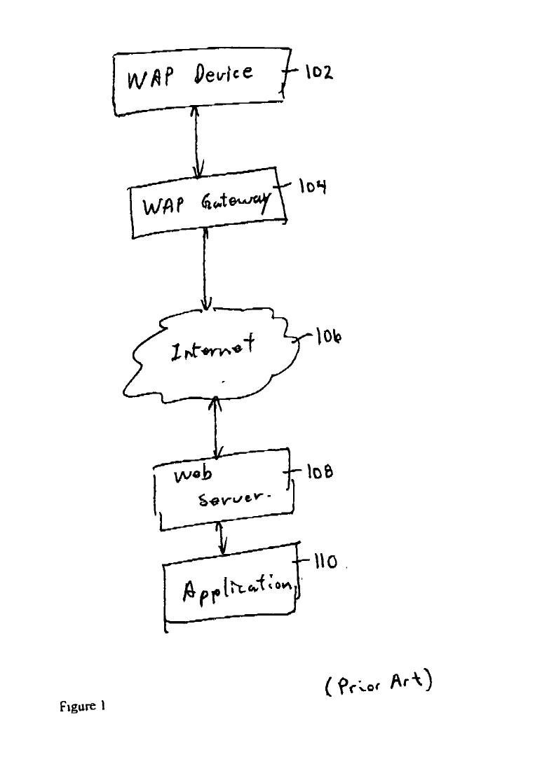

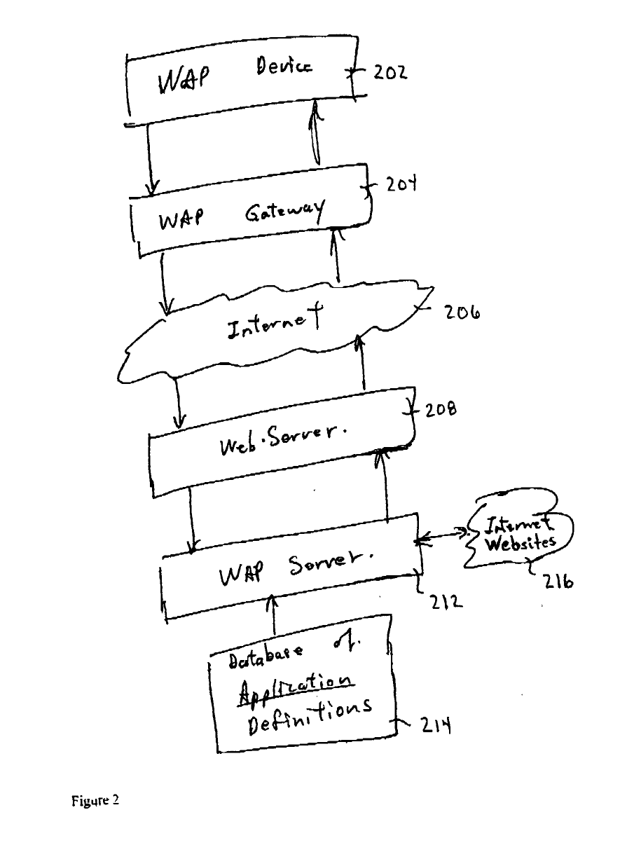

For ease of understanding, the conventional manner by which a WAP compliant wireless device accesses a WAP application over the Internet will firstly be described with reference to FIG. 1. As can be seen, when a WAP compliant wireless device 102 generates a WAP request for an Internet accessible application, the WAP request is forwarded to a WAP gateway 104. The WAP gateway 104 provides an interface between the WAP compliant wireless device 102 and the Internet 106 and supports the overhead necessary for the WAP compliant wireless device to access the Internet 106. The WAP gateway 104 in turn forwards the WAP request, in HTTP format, to a web server 108 hosting the Internet accessible application 110 of interest via the Internet 106. If the Internet accessible application 110 is WAP compliant (i.e. it has WAP request responses pre-coded in WML), the web server 108 returns a WAP response comprised of a deck of WML cards, to the WAP gateway 104 via the Internet 106. The WAP gateway 104 in turn passes the WAP response to the WAP compliant wireless device 102. The browser running on the WAP compliant wireless device 102 executes the WML cards of the WAP response thereby to display the Internet accessible application on its display screen.

If the Internet accessible application 110 is not WAP compliant, the web server 108 returns HTML web pages to the WAP gateway 104 via the Internet 106 in response to the WAP request. The WAP gateway 104, to the extent that it is able, translates the HTML web pages into WML cards before transmitting the WML cards to the WAP compliant wireless device 102. Unfortunately, this process is typically unworkable due to the limitations associated with WAP compliant wireless devices described previously.

FIG. 2 illustrates the manner by which a WAP compliant wireless device accesses a WAP compliant Internet accessible application over the Internet in accordance with the present invention. Similar to the conventional method, when the WAP compliant device 202 generates a WAP request for an Internet accessible WAP application, the WAP request is forwarded to a WAP gateway 204. The WAP gateway 204 in turn forwards a web request to the appropriate web server 208 via the Internet 206. Web server 208 in turn passes a WAP request to a WAP server 212. WAP server 212, in response to the WAP request, reads and interprets application definitions that are specified in a logical order from a database 214 that are appropriate for a WAP response.

The WAP request delivered to the WAP server 212 by the web server 208 is in the form of a Uniform Resource Locator (URL) that includes additional parameters used to pass information to the WAP server 212. This additional information includes, for example, application specific data such as user input data and directions with respect to the next application definition to be processed. The information may further include capability particulars of the WAP compliant wireless device 202 so that the WAP server 212 may generate a WAP response that takes full advantage of the capabilities of the WAP compliant wireless device 202.

The application definitions in the database 214 are created and stored at design time, and are interpreted by the WAP server 212 at run time to dynamically generate WML code in response to the WAP request as will be described. Each application definition in the database 214 defines an action step in the WAP application.

The application definitions are grouped into a plurality of categories. At least one of the application definitions is designated as an anchor and is executed first whenever a WAP request for the WAP application is received. In the present embodiment, the application definitions are grouped into one of three different categories, namely a user interface definitions category, a data definitions category and a flow control definitions category. Each application definition category includes different types of application definitions, with each application definition being designed for a specific purpose.

Table 1 below sets out the application definitions in the user interface definitions category and provides a description of the application definitions in the category and lists the parameters associated with the application definitions. As can be seen, this category includes a display definition, a menu selection definition, an option selection definition and a user input definition. The display definition is designed to display static text or WAP bitmap images on a WAP compliant wireless device. The menu selection definition is designed to display a list of menu items in the form of hyperlinks on a WAP compliant wireless device. The option selection definition is designed to display a list of option items on a WAP compliant wireless device. The user input definition is designed to obtain user input received from a WAP compliant wireless device.

TABLE 1
User Interface Definitions Category

| Type | Description | Parameters |
|---|---|---|
| Display | Display static text or WAP | Static text with formatting |
| | bitmap image on WAP | information (such as bold, |
| | compliant wireless device. | underline, italic, etc); |
| | Text may be displayed in | WAP Bitmap image file; |
| | different formats: different | and Next application |
| | font sizes, underlined, | definition. |
| | bolded and italicized. | |
| Menu Selection | Display a list of selections | Text of the list of menu |
| | for a user to choose from. | items; and Action (i.e., next |
| | The selections are | application definition) for |
| | implemented as a series of | each menu item. |
| | Hyper Links. | |
| Option | Display a list of selections | Text of the list of option |
| Selection | for a user to choose from. | items Variable name for |
| | Mulitple selections are | storing selected options; |
| | allowed. | and Next application |
| | | definition |
| User Input | Obtain user input from | Variable name for storing |
| | WAP compliant wireless | input data; |
| | device. | Default value; |
| | | Input type (text or |
| | | password); |
| | | Optional input only; |
| | | Maximum input length; and |
| | | Next application definition |

Table 2 below sets out the application definitions in the data definitions category. Similarly, a description of the application definitions in the category and the parameters associated with the application definitions are included. As can be seen, this category includes a retrieve data definition, an insert data definition, an update data definition and a delete data definition. The retrieve data definition is designed to retrieve data from a data source. The insert data definition is designed to insert data into a data source. The update data definition is designed to update data in a data source. The delete data definition is designed to delete data from a data source.

TABLE 2
Data Definitions Category

| Type | Description | Parameters |
|---|---|---|
| Retrieve Data | Retrieve data | Data source specification; |
| | from data | Login name and password of the data |
| | source | source; |
| | | Maximum number of records to be |
| | | returned; |
| | | Sorting order of records; |
| | | Language encoding format of the data; |
| | | Retrieval criteria; |
| | | Record fields to be retrieved and |
| | | displayed; and |
| | | Action (i.e., next application definition) |
| | | for success versus failure. |
| Insert Data | Insert data | Data source specification; |
| | to data source | Login name and password of the data |
| | | source; |
| | | Language encoding format of the data; |
| | | Data fields information; and |
| | | Action (i.e., next application definition) |
| | | for success versus failure. |
| Update Data | Update data | Data source specification; |
| | to data source | Login name and password of the data |
| | | source; |
| | | Language encoding format of the data; |
| | | Criteria of records to be updated; |
| | | Data fields to be updated; and |
| | | Action (i.e., next application definition) |
| | | for success versus failure. |
| Delete Data | Delete data | Data source specification; |
| | to data source | Login name and password of the data |
| | | source; |
| | | Language encoding format of the data; |
| | | Deletion criteria; and |
| | | Action (i.e., next application definition) |
| | | for success versus failure. |

Table 3 below sets out the application definitions in the flow control definitions category. Again a description of the application definitions in the category and the parameters associated with the application definitions are included. As can been seen, this category includes an If-Then-Else definition and a function call definition. The If-Then-Else definition is designed to define an “If-Then-Else” logic construct. The function call definition is designed to execute a user defined function.

TABLE 3
Flow Control Defintions Category

| Type | Description | Parameters |
|---|---|---|
| IF-THEN-ELSE | Define an “if-then-else” | Condition variable name; |
| | logic construct in the | Condition operator; |
| | form of: | Condition value; |
| | IF variable operator value | Condition value type; |
| | THEN JUMP TO xx | Case sensitivity |
| | ELSE JUMP TO yy | comparision; and |
| | | Next application |
| | | definition. |
| Function Call | Execute a user defined | Function call Name; and |
| | function | Parameter list. |

The WAP server 212 interprets the application definitions read from the database 214, interacts with Internet websites 216 as required for appropriate data and dynamically creates the WML code for a WAP response. Once created, the WAP response is transmitted to the WAP compliant wireless device 202 via web server 208, Internet 206 and WAP gateway 204. The browser running on the WAP compliant wireless device 202 executes the WAP response thereby to display the WAP application on its display screen.

During the reading and interpreting of application definitions from the database 214, the WAP server 212 enhances the transfer of WML code from the WAP server 212 to the web server by examining the application definitions of the WAP application ahead of time. In this look-ahead process, one or more application definitions are combined to form a deck of WML cards. During the look-ahead process, the WAP server 212 combines as many consecutive application definitions in the user interface definitions category as possible to form a deck of WML cards, but stops the look-ahead process when an application definition in the data definitions category or the flow control definitions category is encountered.

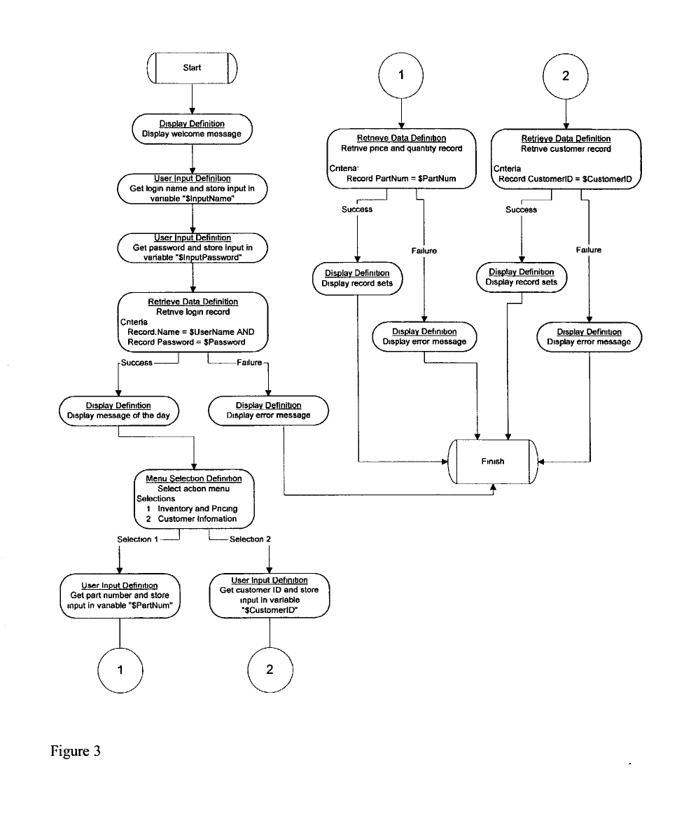

FIG. 3 shows a flow diagram of a WAP application designed to retrieve a price and quantity record as well as a customer record. As should be appreciated, this example is provided for the purpose of illustration only and is not intended to limit the scope of the present invention. The WAP application is constructed using a series of application definitions specified in a logical manner. In this particular example, the application definitions include display definitions, user input definitions, retrieve data definitions and menu selection definitions.

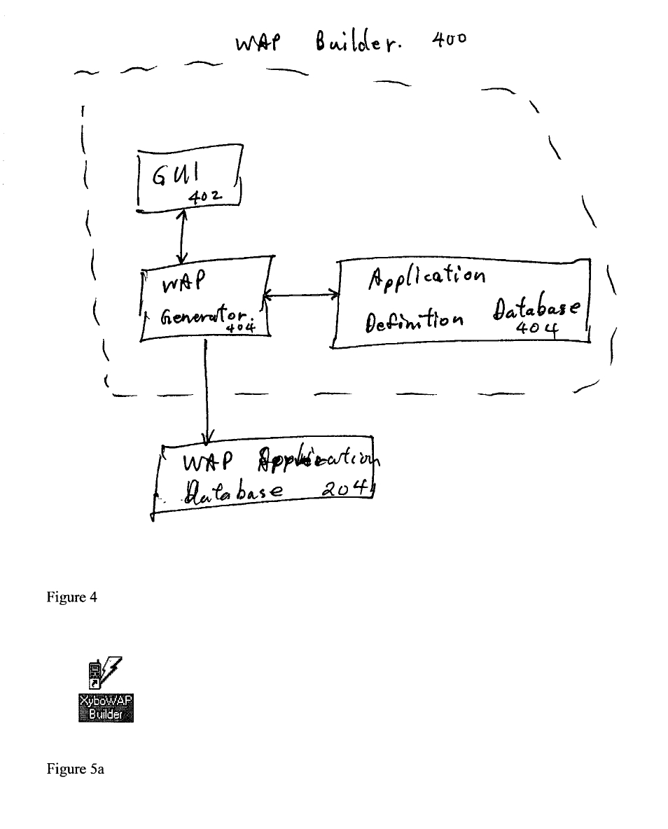

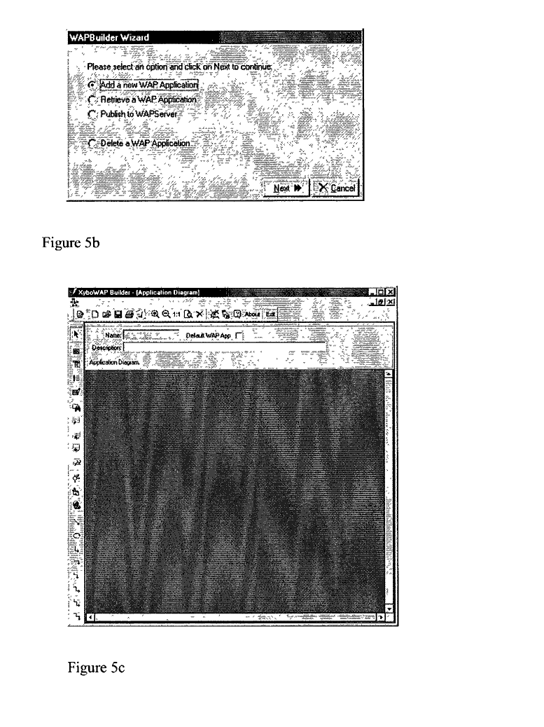

As mentioned previously, the application definitions that are used by the WAP server to generate WAP responses are created at design. In order to create the application definitions, a WAP application builder 400 executed by a computer is provided. FIG. 4 is a schematic block diagram of the WAP application builder and as can be seen, WAP builder 400 includes a graphical user interface (GUI) 402, a WAP generator 404, and a library database 406. During WAP application development, a WAP application developer defines the application definitions through GUI 402. The GUI 402 displays the application definitions in graphical form for ease of use in defining the flow of steps. The library database 406 contains a library of all of the different application definitions in each of the application definition categories.

When a WAP application is to be deployed, the appropriate application definitions making up the WAP application are stored in the database 214 that is accessed by the WAP server 212 in response to WAP requests.

The graphical user interface 402 presents different windows to a WAP application developer that allows the WAP application developer to generate different application definitions by completing the fields of these windows. Once completed, an application definition is created that can be linked to other application definition through a graphical window that presents the logical flow of the WAP application. Upon completion of the graphically defined application definitions, the WAP generator creates WAP application definition data (instructions) for creating WML code to carry out the defined application definitions.

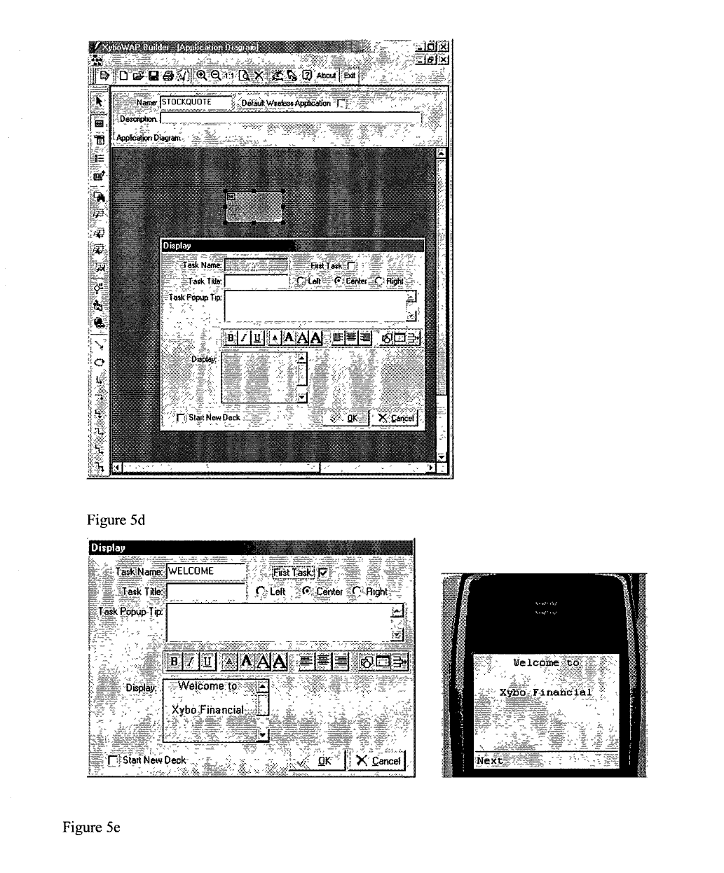

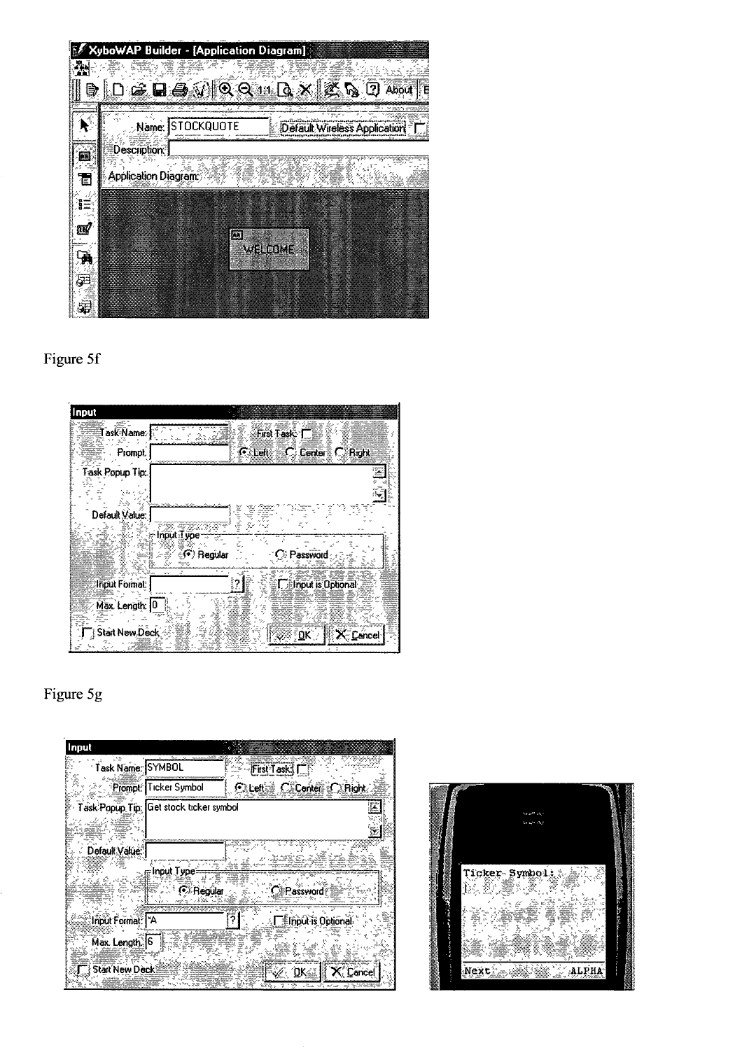

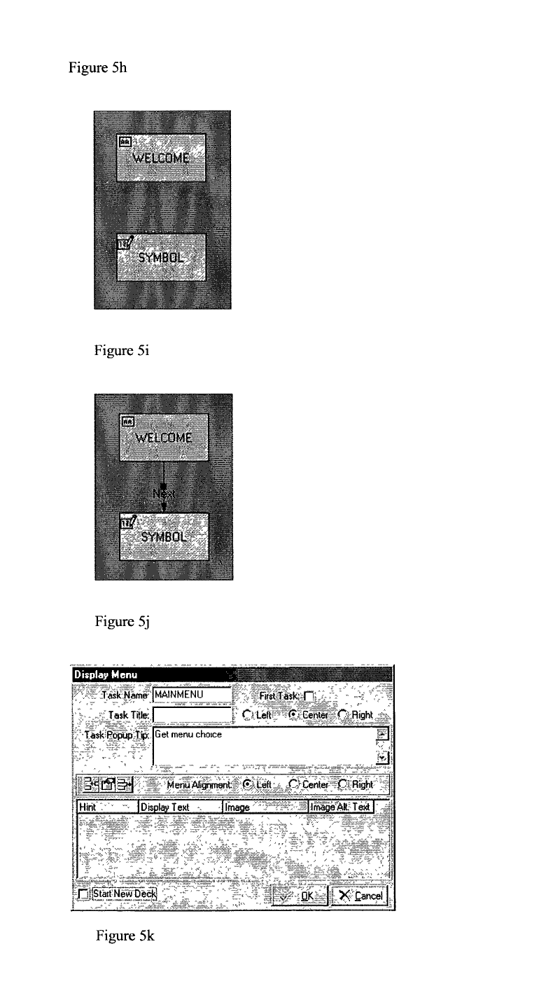

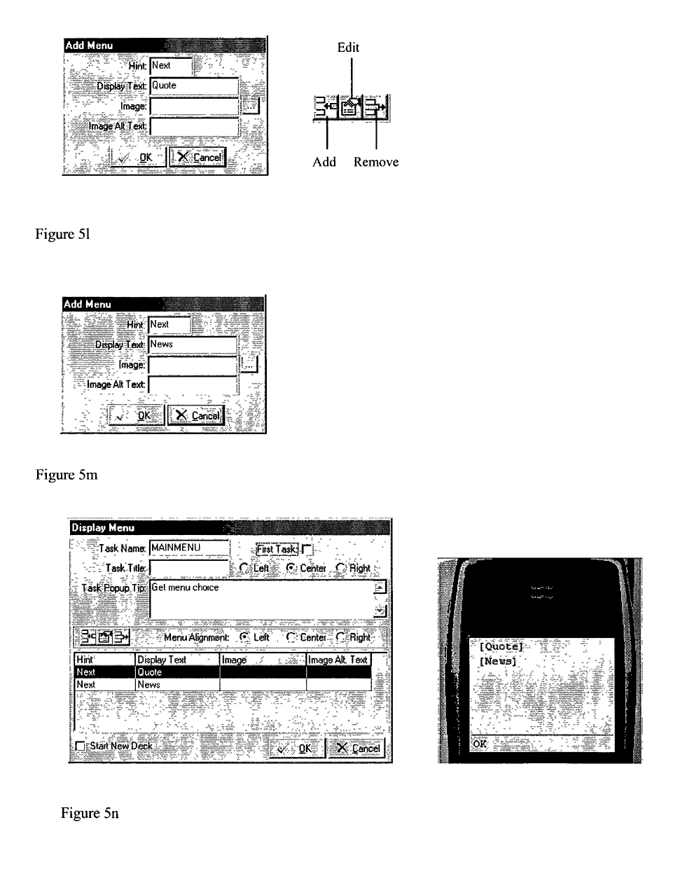

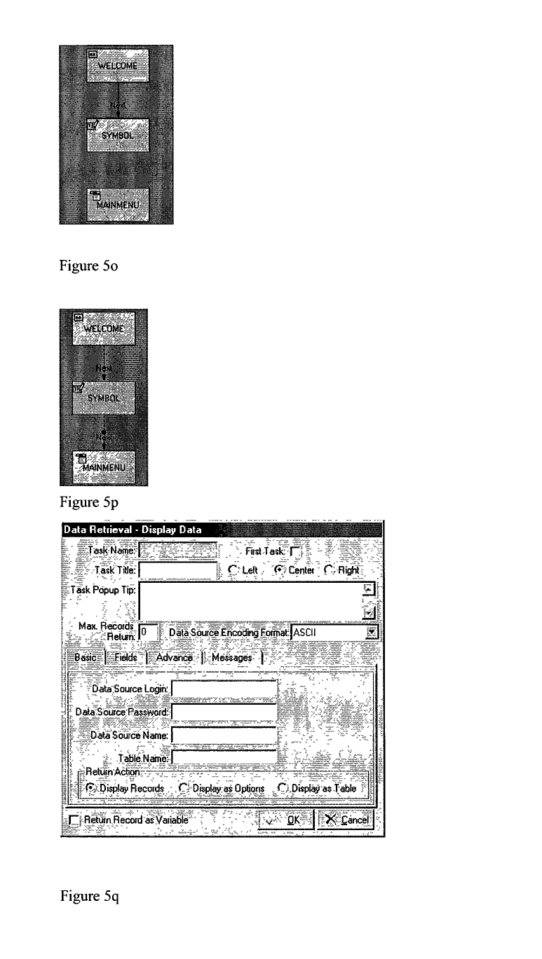

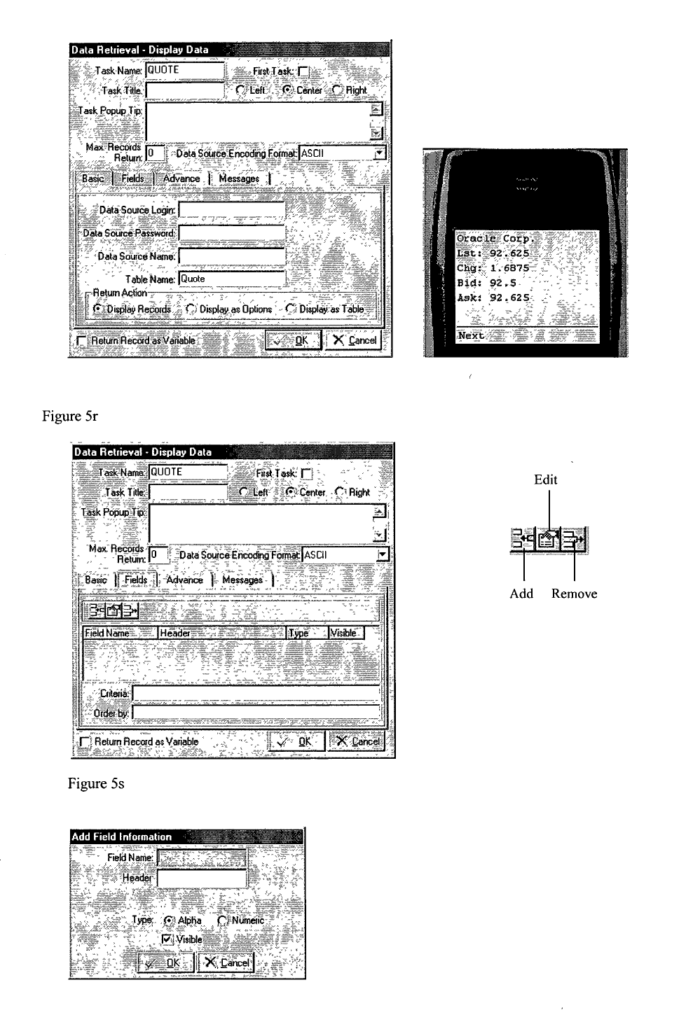

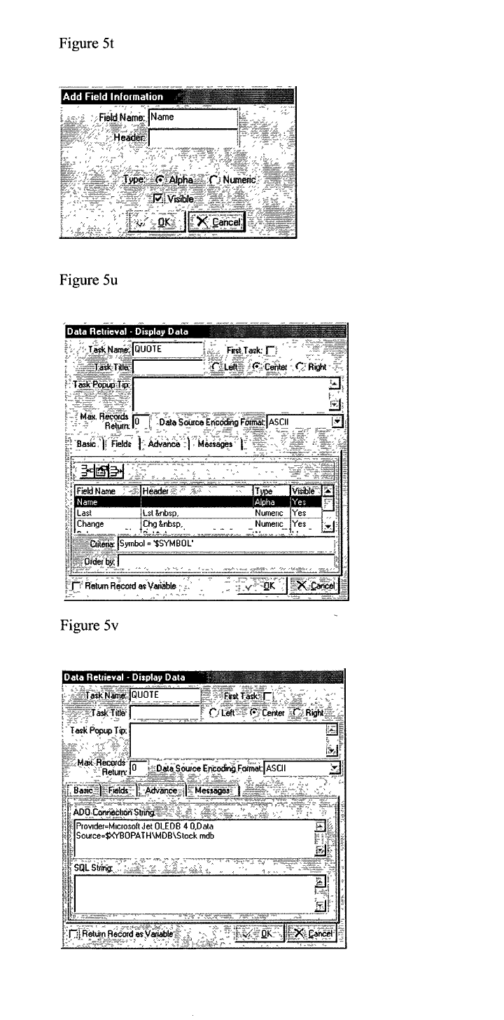

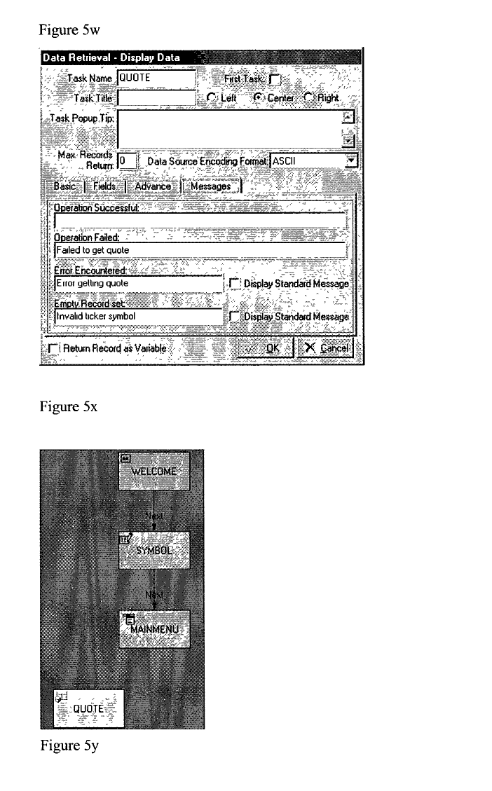

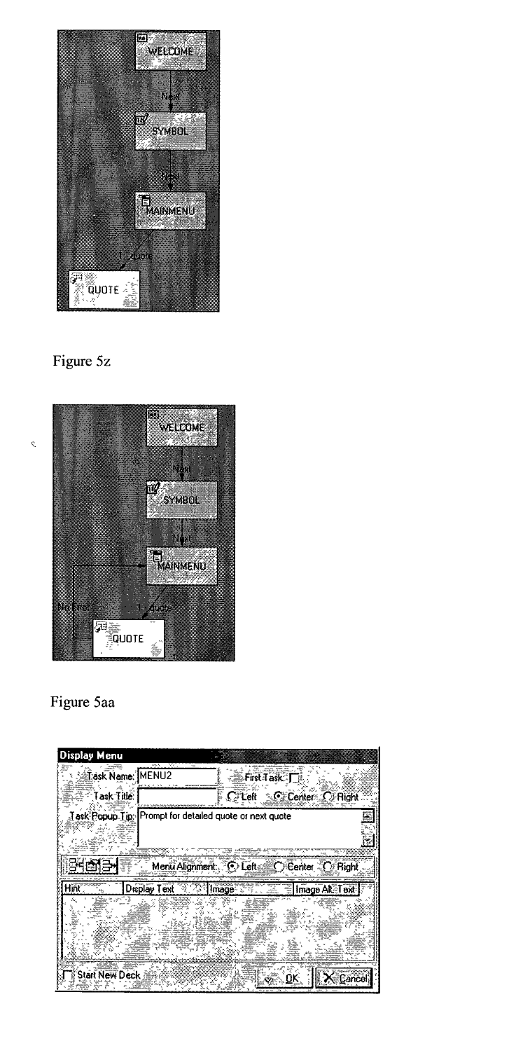

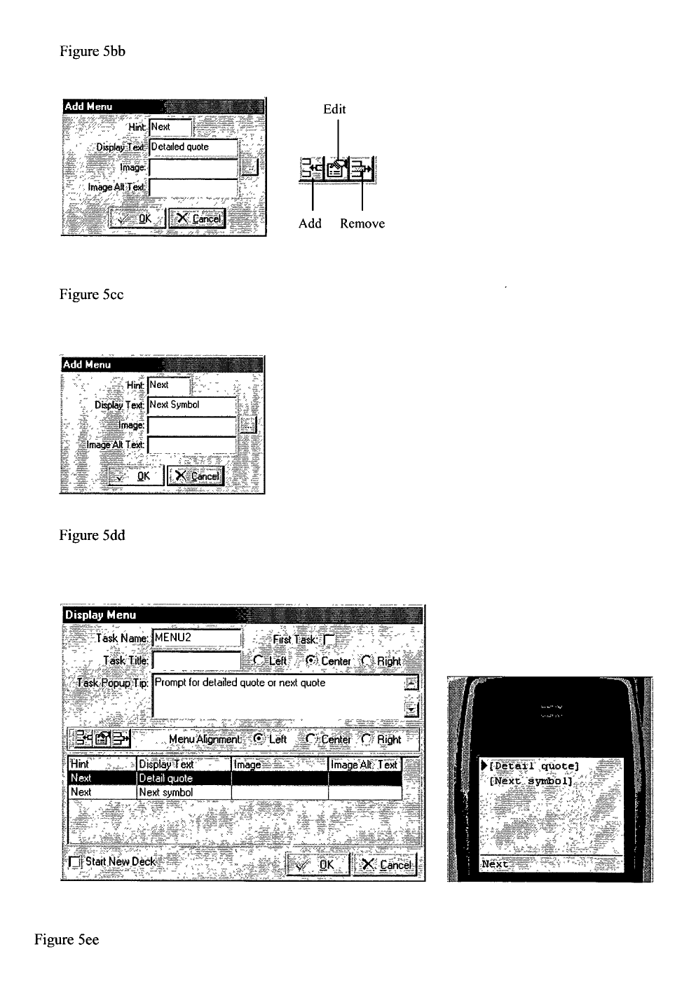

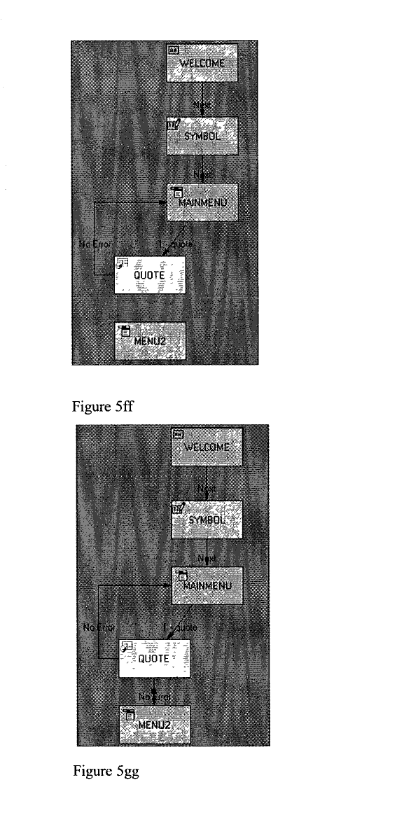

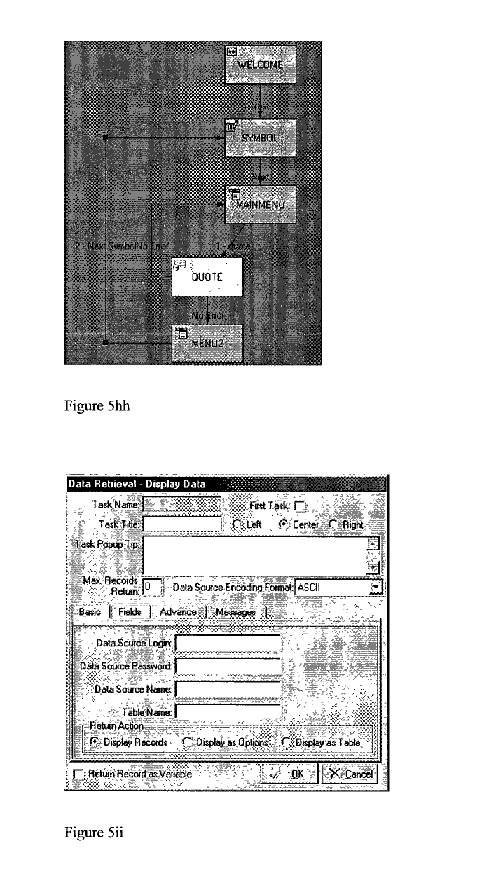

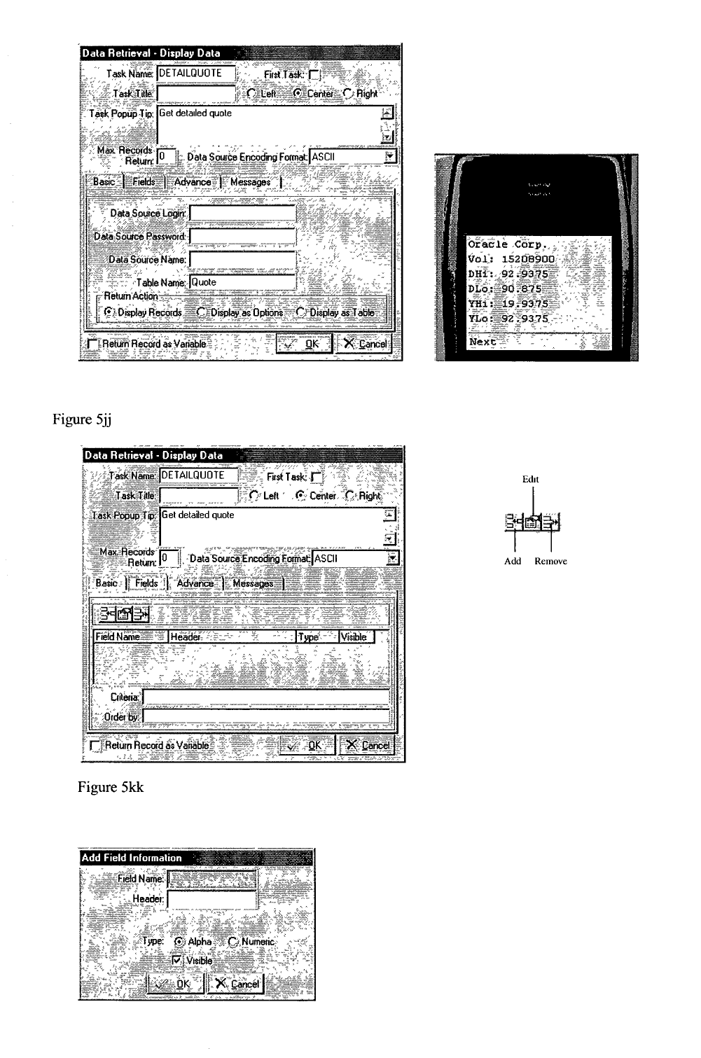

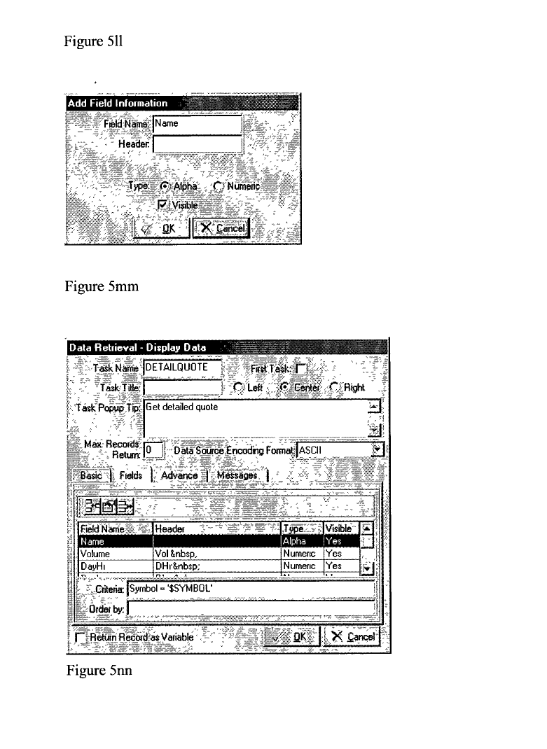

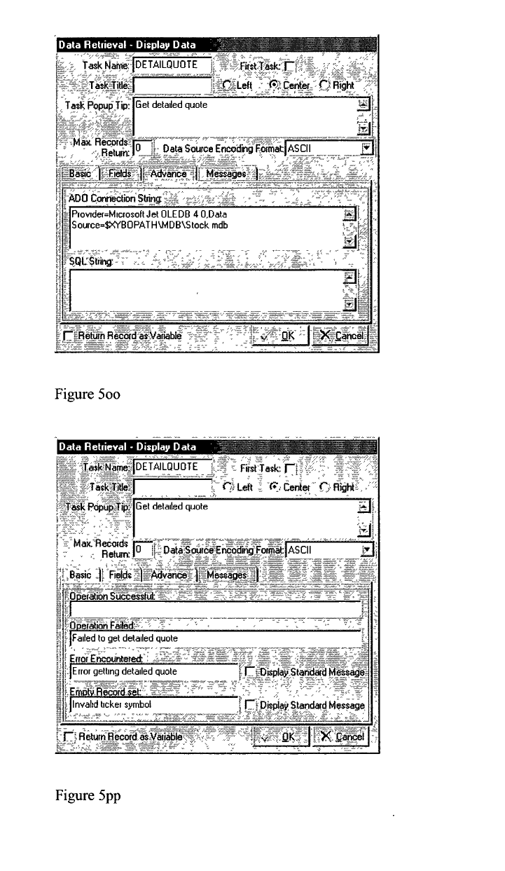

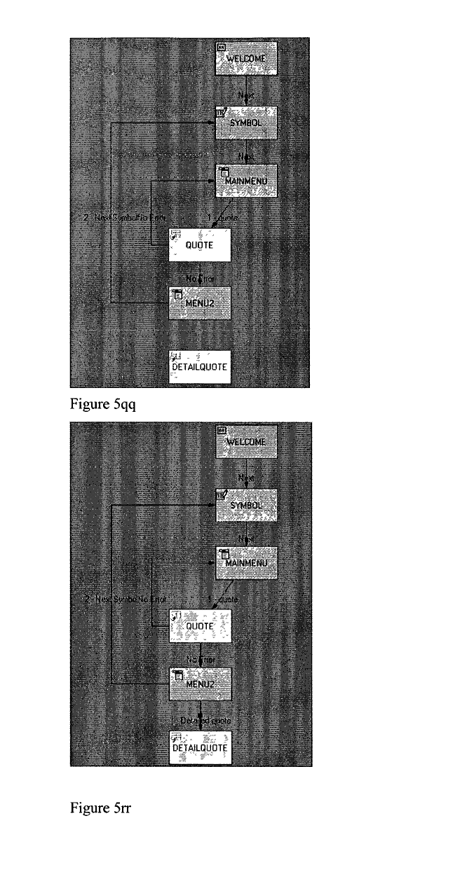

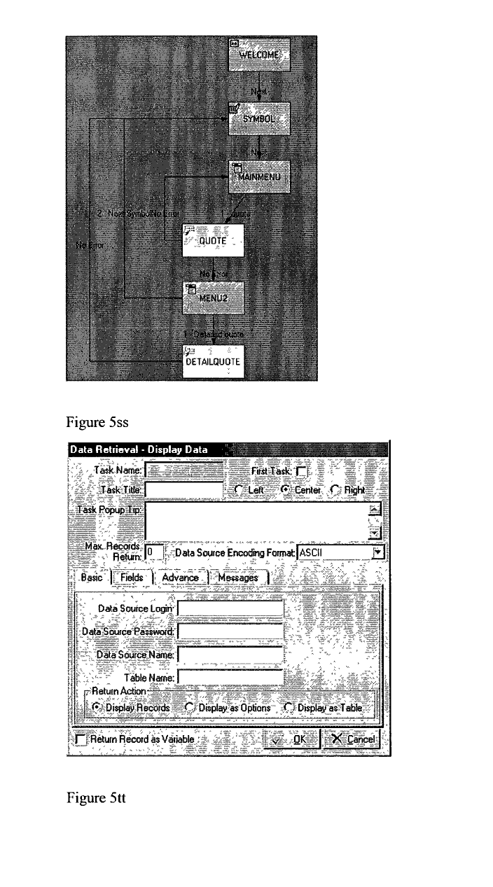

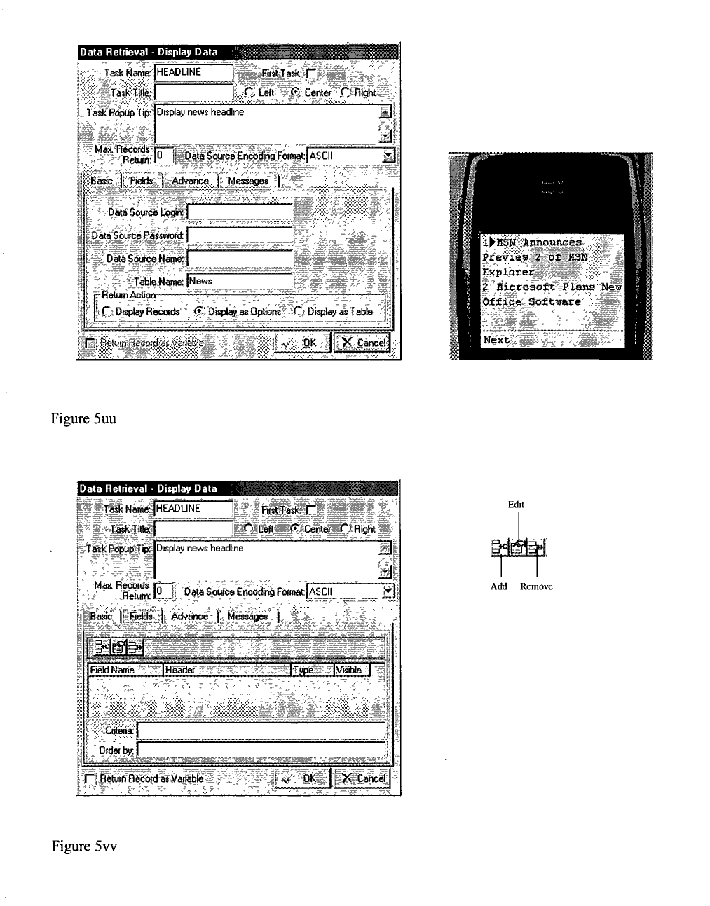

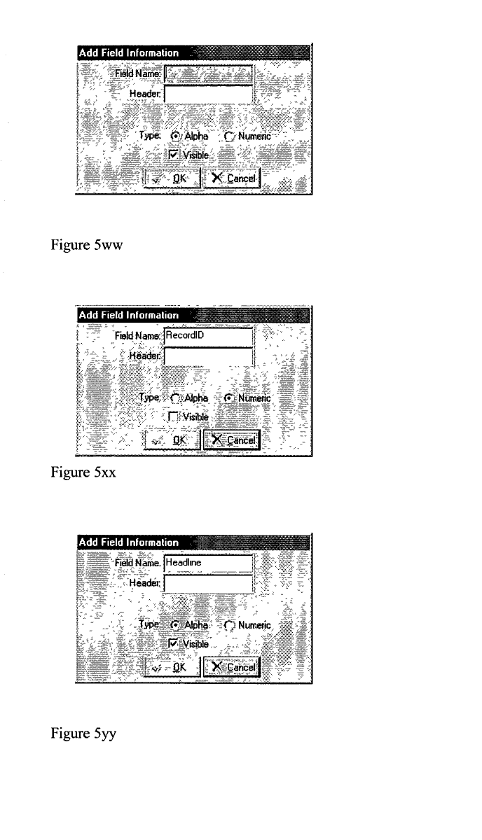

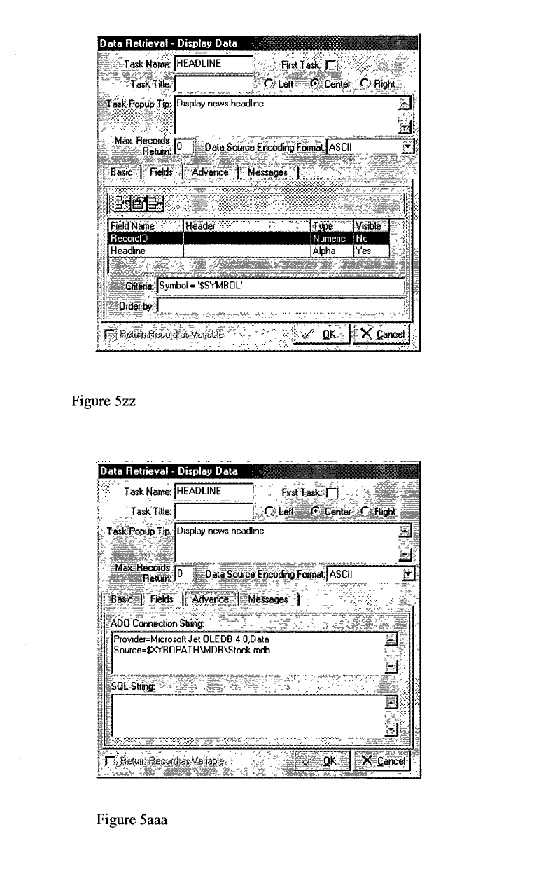

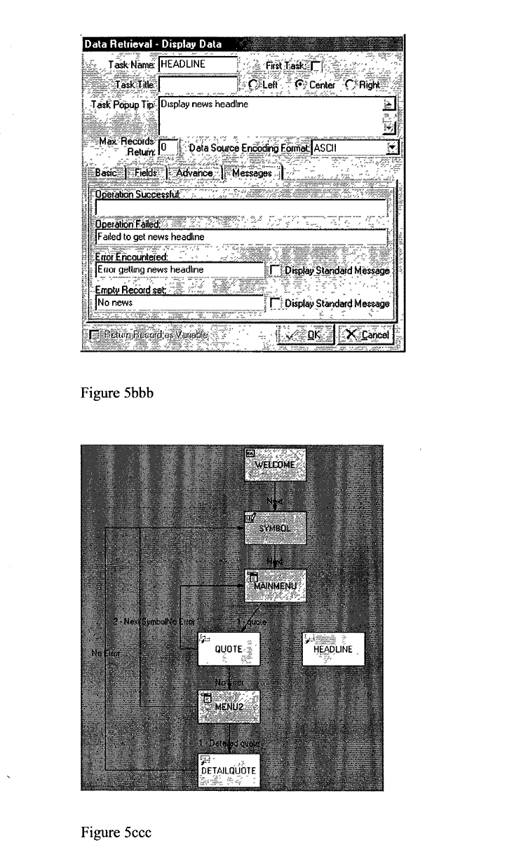

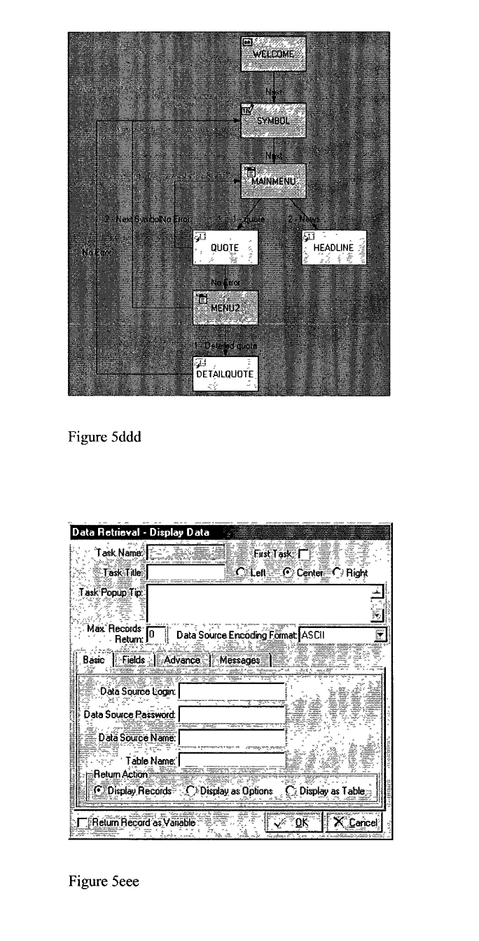

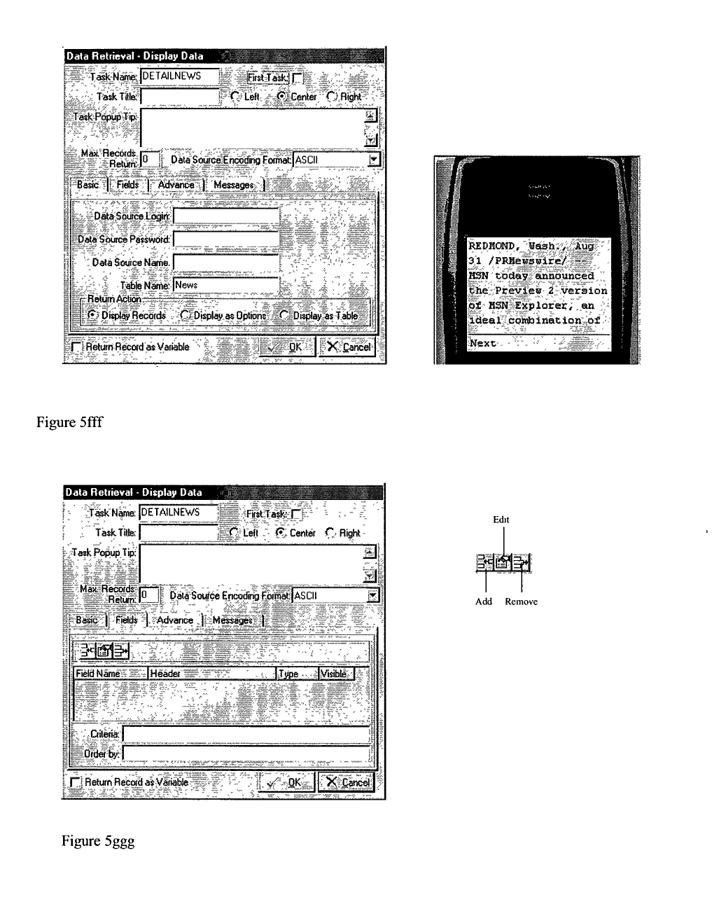

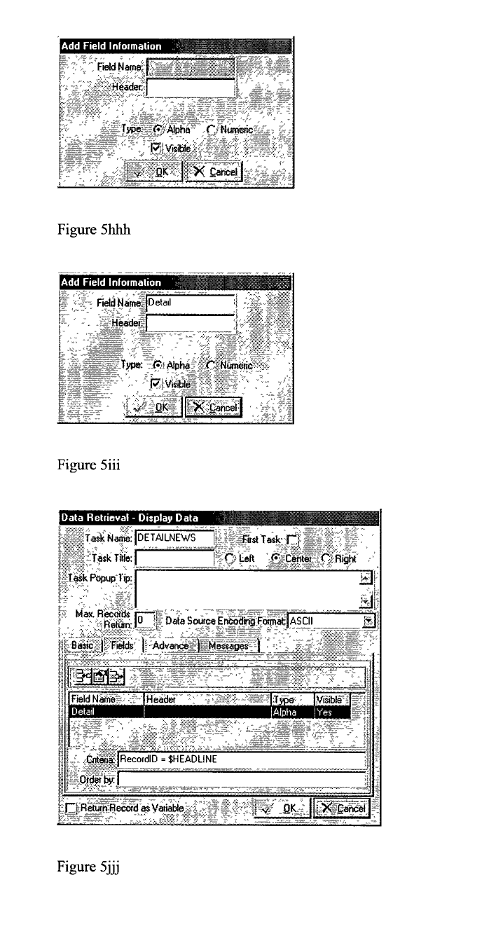

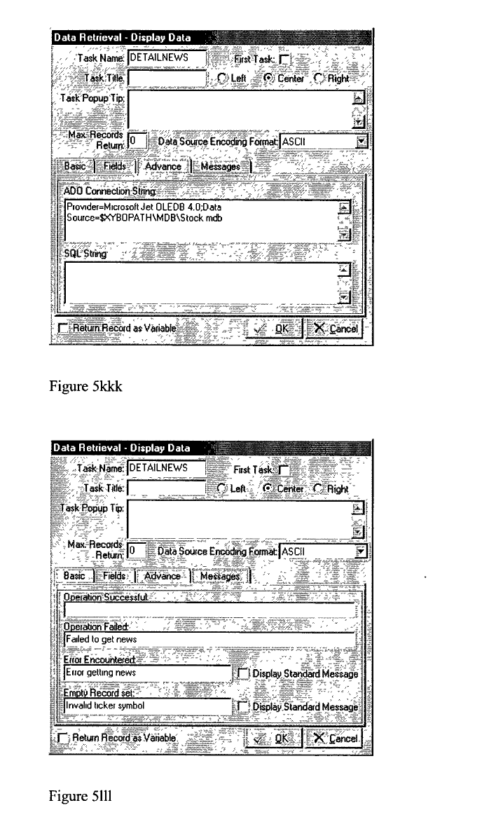

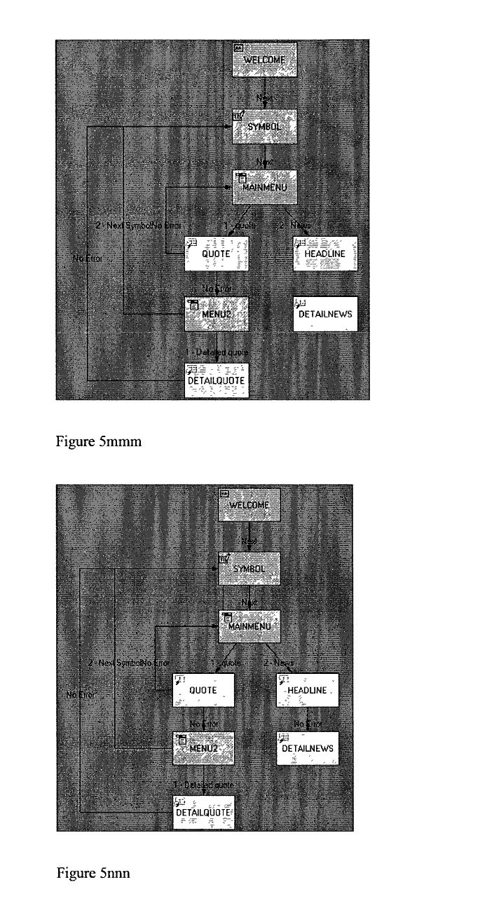

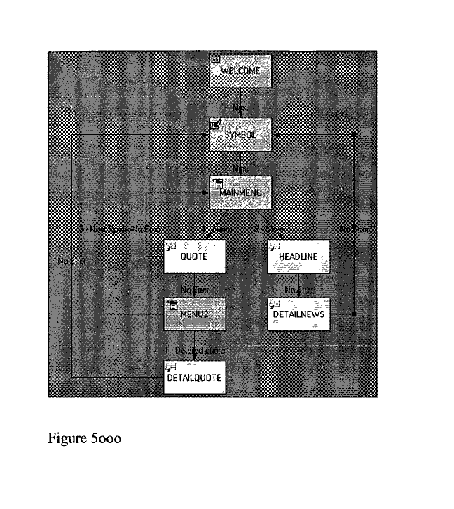

An example of the manner by which a WAP application is created using the WAP application builder will now be described with particular reference to FIGS. 5a to 5ooo. In this particular example, a WAP application for stock quotes is described; however those of skill in the art will appreciate that this description is for the purpose of illustration only and is not intended to limit the scope of the present invention.

Turning now to FIG. 5a, an icon representing the WAP application builder 400 is shown as displayed on the monitor of a computer (not shown). Selection of the icon 500 involves the WAP application builder opens a window that provides the user with a number of options including an “Add new WAP application” option as shown in FIG. 5b. Selecting the “Add new WAP application” option and clicking on the Next button opens a main window as shown in FIG. 5c. The main window includes a name field and a description field to allow the user to name and describe the new WAP application being created.

Following entry of a name and a short description for the WAP application being created into the appropriate fields, the user must click on the display icon of the main window toolbar, click inside the main window, drag the cursor outward and then release the mouse button. When this is done, a display window opens as shown in FIG. 5d. As can be seen, the display window includes a task name field, a task title field and a task pop-up field.

Following entry of the appropriate information into the fields of the display window as shown in FIG. 5e and upon clicking of the “OK” button, a WELCOME task box is created and displayed in the main window as shown in FIG. 5f. Clicking the input icon on the main window toolbar, clicking inside the main window, dragging the cursor outward and then releasing the mouse button causes an input window to open as shown in FIG. 5g. As can be seen, the input window includes a prompt field, a task pop-up tip field, a default value field, an input format field and a maximum length field.

Following entry of the appropriate information into the fields of the input window as shown in FIG. 5h and upon clicking of the “OK” button, a SYMBOL task box is created and displayed in the main window below the WELCOME task box as shown in FIG. 5i. Clicking on the line icon on the main window toolbar, clicking inside the WELCOME task box and then extending the line into the SYMBOL task box joins the WELCOME task box to the SYMBOL task box as shown in FIG. 5j.

Following this, a display menu window is opened by clicking on the menu items icon on the main window toolbar, clicking inside the main window, dragging the cursor outward and then releasing the mouse button as shown in FIG. 5k. As can be seen the display menu includes a task name field, a task title field and a task pop-up tip field as well as menu add, edit and remove buttons. After entry of the appropriate information into the fields of the display menu window, an add menu window is opened by clicking on the add button as shown in FIG. 5l. The add menu window includes a hint field, a display text field, an image field and an image alt text field. FIG. 5l shows the word “Hint” entered in the hint field and the word “Quote” entered in the display text field. FIG. 5m shows another add menu window with the word “Hint” entered in the hint field and the word “News” entered in the display text field.

Once the add menu windows of FIGS. 5l and 5m have been closed by clicking on the OK buttons, the display menu window is updated to show the added menus as shown in FIG. 5n. The task name field and the task pop-up tip fields are shown with entries. Clicking on the OK button of the display menu window, creates a MAINMENU task box that is displayed in the main window below the SYMBOL task box as shown in FIG. 5o. Clicking on the line icon on the main window toolbar, clicking inside the SYMBOL task box and then extending the line into the MAINMENU task box joins the SYMBOL task box to the MAINMENU task box as shown in FIG. 5p.

A data retrieval-display data window is then opened by clicking on a display data icon on the main window toolbar, clicking inside the main window, dragging the cursor outward and then releasing the mouse button as shown in FIG. 5q. The appropriate information is then entered into the fields of the data retrieval-display data window as shown in FIG. 5r.

Selecting the fields tab within the data retrieval-display data window exposes an add button, an edit button and a remove button as shown in FIG. 5s. These buttons permit fields to be modified. Clicking on the add button opens an add field information window as shown in FIG. 5t. A Name field is then added by completing the fields of the field information window as shown in FIG. 5u. Once the fields are completed and the OK button is selected, an appropriate field entry is created and appears under the field tab of the display data window as shown in FIG. 5v. In this particular example, Last, Change, Bid, and Ask field entries also appear under the field tab in FIG. 5v. These field entries are created in the same manner as the Name field entry. The information entered into the fields of the add field information window to create the Last, Change, Bid and Ask field entries is shown in Table 4 below.

TABLE 4

| Field Name | Header | Type | Visible |
|---|---|---|---|
| Last | Lst:&nbsp; | Numeric | Yes |
| Change | Chg:&nbsp; | Numeric | Yes |
| Bid | Bid:&nbsp; | Numeric | Yes |
| Ask | Ask:&nbsp; | Numeric | Yes |

Criteria is then entered into the criteria field of the data retrieval-display data window. The advance tab is then selected in the data retrieval-display data window so that the ADO connection string can be completed as shown in FIG. 5w. The messages tab is then selected to expose the messages fields and the appropriate information is entered into these fields as shown in FIG. 5x. With the above steps performed, the data retrieval-display data window is closed by clicking on the OK button. In response, a QUOTE task box is displayed in the main window below the MAINMENU task box as shown in FIG. 5y. Clicking on the line icon on the main window toolbar, clicking inside the MAINMENU task box and then extending the line into the QUOTE task box joins the MAINMENU task box to the QUOTE task box as shown in FIG. 5z. To link the QUOTE task box back to the MAINMENU task box, a link task box icon is selected, a click is made inside the QUOTE task box, and a line is extended into the MAINMENU task box as shown in FIG. 5aa.

Following this, the display menu window is opened again by clicking on the menu items icon on the main window toolbar, clicking inside the main window, dragging the cursor outward and then releasing the mouse button as shown in FIG. 5bb.

Add menu windows are then opened by clicking on the add button as shown in FIG. 5cc. A “Detailed Quote” menu and a “Next Symbol” menu are created by completing the add menu windows as shown in FIGS. 5cc and 5dd. Once completed, the Detailed Quote menu and Next Symbol menu appear in the display menu window as shown in FIG. 5ee.

Clicking on the OK button of the display menu window creates a MENU2 task box that is displayed in the main window as shown in FIG. 5ff. Clicking on the line icon on the main window toolbar, clicking inside the QUOTE task box and then extending the line into the MENU2 task box joins the QUOTE task box to the MENU2 task box as shown in FIG. 5gg. To link the MENU2 task box back to the SYMBOL task box, the link task box icon is selected, a click is made inside the MENU2 task box, and a line is extended into the SYMBOL task box as shown in FIG. 5hh.

The data retrieval-display data window is then opened again by clicking on the display data icon on the main window toolbar, clicking inside the main window, dragging the cursor outward and then releasing the mouse button as shown in FIG. 5ii. The appropriate information is then entered into the fields of the data retrieval-display data window as shown in FIG. 5jj.

Selecting the fields tab within the data retrieval-display data window exposes the add button, the edit button and the remove button as shown in FIG. 5kk. Clicking on the add button opens the add field information window as shown in FIG. 5ll. A Name field is then added by completing the fields of the field information window as shown in FIG. 5mm. Once the fields are completed and the OK button is selected, an appropriate field entry is created and appears under the field tab of the data retrieval-display data window as shown in FIG. 5nn. In this particular example, Volume, DayHi, DayLo, YearHi, and YearLo field entries also appear under the field tab in FIG. 5nn. These field entries are created in the same manner as the Name field entry. The information entered into the fields of the add field information window to create the Volume, DayHi, DayLo, YearHi, and YearLo field entries is shown in Table 5 below.

TABLE 5

| Field Name | Header | Type | Visible |
|---|---|---|---|
| Volume | Vol:&nbsp; | Numeric | Yes |
| DayHi | Dhi:&nbsp; | Numeric | Yes |
| DayLo | Dlo:&nbsp; | Numeric | Yes |
| YearHi | Yhi:&nbsp; | Numeric | Yes |
| YearLo | Ylo:&nbsp; | Numeric | Yes |

Criteria is then entered into the criteria field of the data retrieval-display data window. The advance tab is then selected in the data retrieval-display data window so that the ADO connection string can be completed as shown in FIG. 5oo. The messages tab is then selected to expose the messages fields and the appropriate information is entered into these fields as shown in FIG. 5pp. With the above steps performed, the data retrieval-display data window is closed by clicking on the OK button. In response, a DETAILQUOTE task box is displayed in the main window below the MENU2 task box as shown in FIG. 5qq. Clicking on the line icon on the main window toolbar, clicking inside the MENU2 task box and then extending the line into the DETAILQUOTE task box joins the MENU2 task box to the DETAILQUOTE task box as shown in FIG. 5rr. To link the DETAILQUOTE task box back to the SYMBOL task box, the link task box icon is selected, a click is made inside the DETAILQUOTE task box, and a line is extended into the SYMBOL task box as shown in FIG. 5ss.

The data retrieval-display data window is then opened by clicking on the display data icon on the main window toolbar, clicking inside the main window, dragging the cursor outward and then releasing the mouse button as shown in FIG. 5tt. The appropriate information is then entered into the fields of the data retrieval-display data window as shown in FIG. 5uu.

Selecting the fields tab within the data retrieval-display data window exposes the add button, the edit button and the remove button as shown in FIG. 5vv. Clicking on the add button opens the add field information window as shown in FIG. 5ww. A RecordID field is then added by completing the fields of the field information window as shown in FIG. 5xx. Once the fields are completed and the OK button is selected, an appropriate field entry is created and appears under the field tab of the data retrieval-display data window as shown in FIG. 5yy. In this particular example, a Headline field entry also appears under the field tab in FIG. 5yy. This field entry is created in the same manner as the Headline field entry.

Criteria is then entered into the criteria field of the data retrieval-display data window as shown in FIG. 5zz. The advance tab is then selected in the data retrieval-display data window so that the ADO connection string can be completed as shown in FIG. 5aaa. The messages tab is then selected to expose the messages fields and the appropriate information is entered into these fields as shown in FIG. 5bbb. With the above steps performed, the data retrieval-display data window is closed by clicking on the OK button. In response, a HEADLINE task box is displayed in the main window as shown in FIG. 5ccc. Clicking on the line icon on the main window toolbar, clicking inside the MAINMENU task box and then extending the line into the HEADLINE task box joins the MAINMENU task box to the HEADLINE task box as shown in FIG. 5ddd.

The data retrieval-display data window is then opened yet again by clicking on the display data icon on the main window toolbar, clicking inside the main window, dragging the cursor outward and then releasing the mouse button as shown in FIG. 5eee. The appropriate information is then entered into the fields of the display data window as shown in FIG. 5fff.

Selecting the fields tab within the data retrieval-display data window exposes the add button, the edit button and the remove button as shown in FIG. ggg. Clicking on the add button opens the add field information window as shown in FIG. 5hhh. A Detail field is then added by completing the fields of the field information window as shown in FIG. 5iii. Once the fields are completed and the OK button is selected, an appropriate field entry is created and appears under the field tab of the data retrieval-display data window as shown in FIG. 5jjj.

Criteria is then entered into the criteria field of the data retrieval-display data window as shown in FIG. 5jjj. The advance tab is then selected in the data retrieval-display data window so that the ADO connection string can be completed as shown in FIG. 5kkk. The messages tab is then selected to expose the messages fields and the appropriate information is entered into these fields as shown in FIG. 5lll. With the above steps performed, the data retrieval-display data window is closed by clicking on the OK button. In response, a DETAILNEWS task box is displayed in the main window as shown in FIG. 5mmm. Clicking on the line icon on the main window toolbar, clicking inside the HEADLINE task box and then extending the line into the DETAILNEWS task box joins the HEADLINE task box to the DETAILNEWS task box as shown in FIG. 5nnn. To link the DETAILNEWS task box back to the SYMBOL task box, the link task box icon is selected, a click is made inside the DETAILNEWS task box, and a line is extended into the SYMBOL task box as shown in FIG. 5ooo.

By completing the above steps, a stock quote WAP application is generated based on a number of application definitions created through the graphical user interface 402. As will be appreciated, the graphical user interface provides a commercial facility for WAP application developers to create the application definitions while avoiding technical details associated with WAP specifications.

Although a preferred embodiment of the present invention has been described, it will be understood by those skilled in the art that variations and modifications may be made thereto without departing from the spirit of the invention or the scope of the appended claims.

What is claimed is:

1. A method of conveying a WAP application to a WAP compliant wireless device comprising the steps of:
in response to a WAP request generated by the WAP compliant wireless device, reading application definitions from a database that are appropriate for generating a WAP response to said WAP request;
generating WML code forming said WAP response using the application definitions read from said database; and
transmitting said WAP response to said WAP compliant wireless device.

2. The method of claim 1 wherein said WML code is generated dynamically using the application definitions.

3. The method of claim 2 further comprising the step of accessing data from Internet sites during said WML code generating.

4. A method of conveying a WAP application to a WAP compliant wireless device comprising the steps of:
generating a WAP request using a WAP compliant wireless device;
conveying the WAP request to a WAP gateway;
at the WAP gateway generating a web request in response to the WAP request and conveying the web request to a web server over the Internet;
at the web server generating a WAP request in response to the web request and conveying the WAP request to a WAP server;
at said WAP server reading application definitions from a database that are appropriate for generating a WAP response in response to said WAP request and dynamically generating WML code forming said WAP response using the application definitions read from said database; and
transmitting said WAP response to said WAP compliant wireless device via said web server, Internet and WAP gateway.

5. The method of claim 4 further comprising the step of accessing data from Internet sites during said WML code generating.

6. The method of claim 5 wherein said WAP request includes information concerning the capabilities of said WAP compliant wireless device.

7. A system for conveying a WAP application to a WAP compliant wireless device comprising:
a WAP compliant wireless device generating a WAP request;
a WAP gateway generating a web request in response to the WAP request and conveying the web request to a web server over the Internet; and
a WAP server reading application definitions from a database that are appropriate for generating a WAP response in response to said WAP request and dynamically generating WML code forming said WAP response using the application definitions read from said database, said WAP server transmitting said WAP response to said WAP compliant wireless device via said web server, Internet and WAP gateway.

8. A system according to claim 7 wherein said WAP server further accesses Internet sites for data during generation of said WML code.

9. A system according to claim 8 wherein each of said application definitions includes a description and parameters, said parameters defining information associated with said application definitions.

10. A system according to claim 9 wherein said application definitions are grouped into categories.

11. A system according to claim 10 wherein said categories include a user interface definitions category, a data definitions category and a flow control definitions category.

12. A system according to claim 11 wherein said user interface definitions category includes a display definition, a menu selection definition, an option selection definition and a user input definition.

13. A system according to claim 11 wherein said data definitions category includes a retrieve data definition, an insert data definition, an update definition and a delete data definition.

14. A system according to claim 11 wherein said flow control definitions include an If-Then-Else definition and a function call definition.

15. A system according to claim 12 wherein said display definition includes instructions for generating WML code to display static text and WAP bitmap images on said WAP compliant wireless device; said menus selection definition includes instructions for generating WML code to display a list of menu items as hyperlinks on said WAP compliant wireless device; said option selection definition includes instructions for generating WML code to display option items on said WAP compliant wireless device; and said user input definition includes instructions for generating WML code to obtain user input from said WAP compliant wireless device.

16. A system according to claim 13 wherein said retrieve data definition includes instructions for generating WML code to retrieve data from a data source; said insert data definition includes instructions for generating WML code to insert data to a data source; said update data definition includes instructions for generating WML code to update data in a data source; and said delete data definition includes instructions for generating WML code to delete data from a data source.

17. A system according to claim 14 wherein said If-Then-Else definition includes instructions for generating WML code to create an if-then-else logic construct and said function call definition includes instructions for generating WML code to call a subroutine.

18. A WAP application builder comprising:
a graphical user interface defining WAP application definitions in response to user input; and
a WAP generator creating application definition data in response to defined application definitions.

19. A WAP application builder according to claim 18 wherein said graphical user interface presents windows for said application definitions.

20. A WAP application builder according to claim 19 wherein said graphical user interface presents the logical flow of said application definitions.

21. A WAP application builder according to claim 20 further comprising a database storing said application definitions, said application definitions being grouped into categories including a user interface definitions category, a data definitions category and a flow control definitions category.

22. A WAP application builder according to claim 21 and wherein said user interface definitions category includes a display definition, a menu selection definition, an option selection definition and a user input definition.

23. A WAP application builder according to claim 22 wherein said data definitions category includes a retrieve data definition, an insert data definition, an update definition and a delete data definition.

24. A WAP application builder according to claim 23 wherein said flow control definitions include an If-Then-Else definition and a function call definition.

25. A WAP application builder according to claim 24 wherein said display definition includes instructions for generating WML code to display static text and WAP bitmap images on said WAP compliant wireless device; said menus selection definition includes instructions for generating WML code to display a list of menu items as hyperlinks on said WAP compliant wireless device; said option selection definition includes instructions for generating WML code to display option items on said WAP compliant wireless device; and said user input definition includes instructions for generating WML code to obtain user input from said WAP compliant wireless device.

26. A WAP application builder according to claim 25 wherein said retrieve data definition includes instructions for generating WML code to retrieve data from a data source; said insert data definition includes instructions for generating WML code to insert data to a data source; said update data definition includes instructions for generating WML code to update data in a data source; and said delete data definition includes instructions for generating WML code to delete data from a data source.

27. A WAP application builder according to claim 26 wherein said If-Then-Else definition includes instructions for generating WML code to create an if-then-else logic construct and said function call definition includes instructions for generating WML code to call a subroutine.

28. A method for building a WAP application comprising the steps of:
defining WAP application definitions in response to user input through a graphical user interface; and
creating application definition data in response to defined application definitions.

29. The method of claim 28 further comprising the step of presenting windows for said application definitions.

30. A WAP application builder according to claim 29 further comprising the step of presenting the logical flow of said application definitions.
